(19) United States
(12) Patent Application Publication
(10) Pub. No.: US 2018/0150904 A1
(43) Pub. Date: May 31, 2018

(54) DATA FILTER AND DELIVERY COORDINATION

(71) Applicant: Wal-Mart Stores, Inc., Bentonville, AR (US)

(72) Inventors: Parvez Musani, Bentonville, AR (US); Todd D. Mattingly, Bentonville, AR (US)

(21) Appl. No.: 15/825,637

(22) Filed: Nov. 29, 2017

Related U.S. Application Data
(60) Provisional application No. 62/427,476, filed on Nov. 29, 2016.

(51) Int. Cl. G06Q 30/06; H04L 29/08; H04W 4/04; G06Q 50/28; G01C 21/00

(52) U.S. Cl. CPC G06Q 30/0639; H04L 29/08657; G01C 21/005; G06Q 50/28; H04W 4/04

(57) ABSTRACT

An apparatus to coordinate physical exchanges includes a network interface configured to receive presence information corresponding to a receiving entity and to transmit coordinating information, wherein the network interface operably couples to a control circuit. The control circuit also operably couples to a memory having stored information regarding physical-exchange areas. The control circuit determines a present location for the aforementioned receiving entity using, at least in part, the presence information and then uses that present location to filter the information regarding physical-exchange areas to thereby identify a viable physical-exchange area that is sufficiently near the present location. The control circuit then transmits coordinating information that identifies the viable physical-exchange area to both the receiving entity and to the delivering entity via the network interface to thereby coordinate a delivery of a physical item from the delivery entity to the receiving entity.

### CROSS-REFERENCE TO RELATED APPLICATION

This application claims the benefit of U.S. Provisional Application No. 62/427,476, filed Nov. 29, 2016, and is incorporated herein by reference in its entirety.

### TECHNICAL FIELD

These teachings relate generally to data filtering and more particularly to the use of filtered data to coordinate actions.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for “bricks and mortar” retailers to focus on improving the overall customer experience and/or convenience.

The foregoing can include providing and/or enhancing product delivery service. Whether the customer buys a product in a traditional retail shopping facility or via an online opportunity, many customers are seeking the convenience of having their purchases delivered to their homes, offices, hotel rooms, dormitories, or other places of residence or work.

Unfortunately, existing delivery paradigms are generally ineffective at dealing with real-time ambiguity regarding delivery destination targets. As retailers work to shorten the total cycle time from order to delivery, however, such ambiguity is going to increase. Such ambiguity can lead to increased delivery times, missed deliveries, and other scenarios that can lead to customer dissatisfaction.

### BRIEF DESCRIPTION OF THE DRAWINGS

The above needs are at least partially met through provision of the data filter and delivery coordination apparatus and method described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a call-flow diagram as configured in accordance with various embodiments of these teachings; and

FIG. 4 comprises a block diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments an apparatus to coordinate physical exchanges includes a network interface configured to receive presence information corresponding to a receiving entity and to transmit coordinating information, wherein the network interface operably couples to a control circuit. The control circuit also operably couples to a memory having stored information regarding physical-exchange areas. The control circuit determines a present location for the aforementioned receiving entity using, at least in part, the presence information and then uses that present location to filter the information regarding physical-exchange areas to thereby identify a viable physical-exchange area that is sufficiently near the present location. The control circuit then transmits coordinating information that identifies the viable physical-exchange area to both the receiving entity and to the delivering entity via the network interface to thereby coordinate a delivery of a physical item from the delivery entity to the receiving entity.

By one approach the aforementioned presence information comprises one or more of latitude and longitude information, internal guidance information, and destination information identified in a navigation component.

By one approach the aforementioned delivery entity comprises an enterprise different than the enterprise from whom the receiving entity ordered and purchased the physical item. Alternatively, the receiving entity can comprise a part of the enterprise from whom the receiving entity ordered and purchased the physical item.

These teachings are highly flexible in practice and will accommodate a variety of application settings. By one approach the aforementioned viable physical-exchange area comprises a vehicular parking area such as a public vehicular parking area.

As another example, by one approach the control circuit can be configured to receive a communication from the receiving entity (or, if desired, from the delivering entity) that characterizes the aforementioned viable physical-exchange area as being non-viable. In such a case, the control circuit can then be configured to respond to such a communication by identifying an alternative viable physical-exchange area that is again sufficiently near the present location of the receiving party and then transmitting supplemental coordinating information to the aforementioned entities that identifies the alternative viable physical-exchange area to thereby again coordinate the delivery of the physical item from the delivery entity to the receiving entity.

So configured, a physical delivery to a purchaser can be reliably and conveniently made directly to the purchaser without requiring the receiving entity to, for example, remain at their residence or office while awaiting the delivery. Instead, the purchaser can go about their other business and travels knowing that their delivery can and will occur within an appropriate timeframe at some mutually convenient exchange point.

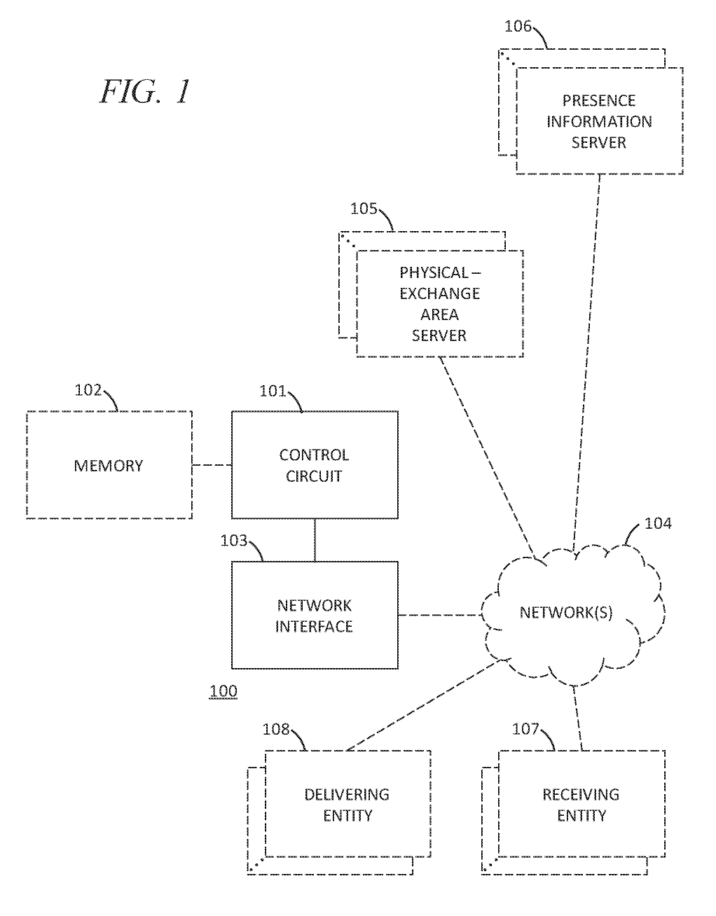

These and other benefits may become clearer upon making a thorough review and study of the following detailed description. Referring now to the drawings, and in particular to FIG. 1, an illustrative application setting that includes a corresponding enabling apparatus 100 that is compatible with many of these teachings will now be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to information regarding various physical-exchange areas as described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

In this example the control circuit 101 also operably couples to a network interface 103. So configured the control circuit 101 can communicate with other elements (both within the apparatus 100 and external thereto) via the network interface 103. In particular, the network interface 103 communicatively couples to one or more networks 104 such as but not limited to local area networks (LAN's), wireless telephony/data networks, and/or the Internet (i.e., the global system of interconnected computer networks that use the Internet protocol suite (TCP/IP) to link devices worldwide). Network interfaces, including both wireless and non-wireless platforms, are well understood in the art and require no particular elaboration here.

By one optional approach the application setting includes one or more physical-exchange area servers 105. These servers 105 gather and/or store information regarding physical-exchange areas that are present in a given geographic region such as a particular municipality or other area of interest. A “physical-exchange area” can comprise a vehicular parking area such as a public vehicular parking area (for example, municipal and privately-operated parking lots, multi-level parking structures, and on-street parking facilities including both metered and non-metered parking spaces). The stored information can, if desired, characterize each parking space with respect to one or more of accessibility limitations, size limitations, weight limitations, cost requirements, zoning restrictions or other regulatory limitations, and current availability.

By another optional approach, in lieu of the foregoing or in combination therewith, the application setting may include one or more presence information servers 106. As used herein, the word “presence” refers to physical presence rather than virtual presence. More particularly, the presence information corresponds to a current (or at least planned) physical presence of a receiving entity. When the receiving entity constitutes a person, the presence information may be relatively direct (when, for example, the source presence information is supplied by a portable device, such as a so-called smart phone, that the person carries) or more indirect (when, for example, the source presence information is supplied by, for example, a vehicle being used by the person).

Also illustrated in FIG. 1, and as presumed for the sake of an illustrative example, the application setting also includes at least one receiving entity 107 and at least one delivering entity 108. The receiving entity 107 will typically comprise a person who ordered a physical product from a corresponding first enterprise such as a bricks-and-mortar retailer and/or an on-line retailer. These teachings will also accommodate the receiving entity 107 comprising a business where more than one person may be available to receive an item.

The delivering entity 108 will typically comprise a delivery modality that may or may not include a person to personally hand the item to the receiving entity 107. Accordingly, the delivering entity 108 may comprise a wholly or partially human-piloted and/or human-manned vehicle or may comprise a wholly or partially autonomously-piloted and/or autonomously-operated vehicle. These teachings will accommodate all manner of vehicular designs including terrestrial vehicles, airborne vehicles, and waterborne vehicles. These teachings will also accommodate having the delivering entity be wholly owned and operated by the same enterprise that sold the item to be delivered, or, if desired, the delivering entity may comprise a delivery modality that is owned and/or operated by a different enterprise than the first enterprise. These teachings will further accommodate using multiple delivery modalities that may be owned and/or operated by different enterprises as part of a single chain of delivery to provide the ordered item to the receiving entity 107.

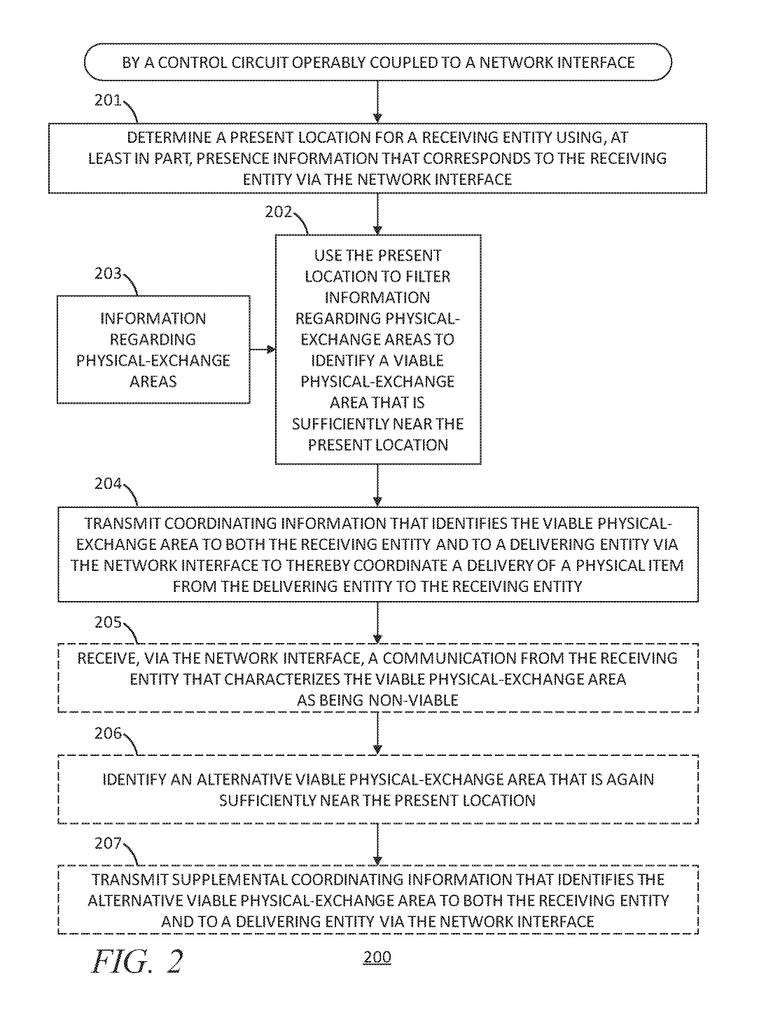

Referring now to both FIGS. 1 and 2, for the sake of an illustrative example the process 200 shown in FIG. 2 is presumed for the purpose of this description to be carried out by the aforementioned control circuit 101. This description will also presume that the receiving entity 107 has already previously ordered an item from the aforementioned first enterprise and that the ordered item is now available and ready to traverse the final segment of the delivery chain to the receiving party 107.

At block 201 the control circuit 101 determines a present location for the receiving entity 107 using, at least in part, presence information that corresponds to the receiving entity 107. This description presumes that the receiving entity 107 is not presently at any previously-provided delivery address (such as a residential address or a business address). When the receiving entity 107 is at their delivery address, an alternative delivery process can be used, if desired, to simply deliver the ordered item to that delivery address.

As noted above, some or all of this presence information can be received and made available to the control circuit 101 via the aforementioned network interface 103. This presence information may be provided in whole or in part by one or more physical-exchange area servers 105 or may be provided in whole or in part by a device associated with the receiving entity 107 (for example, the receiving entity's so-called smart phone). This presence information may be real-time or near real-time (for example, within a short delay time of actual real time, such as 1 to 15 seconds or 1 to 10 minutes).

At block 202 the control circuit 101 uses the present location information to filter available information 203 regarding physical-exchange areas (such as, for example, vehicular parking areas including, if desired, both private and public vehicular parking areas). In particular, the control circuit 101 filters that information to identify a viable physical-exchange area that is sufficiently near the present location of the receiving entity 107.

The “sufficiently near” criterion can constitute a static or dynamic parameter as desired. For example, the “sufficiently near” criterion can stipulate, at all times and under all circumstances, that physical delivery of an item must occur within a predetermined distance of the receiving entity's present location (such as within 100 feet, 500 feet, half a mile, or some other predetermined distance). When the “sufficiently near” criterion constitutes a dynamic parameter, a permitted delivery radius may vary depending upon such things as the day of the week, the time of day, weather conditions, crime statistics local to the present location, and so forth. For example, a reduced permitted delivery radius may apply during inclement weather or during hours of ambient darkness.

The “viable” criterion refers to whether a particular physical-exchange area is minimally suitable for purposes of effecting a physical delivery of the item to the receiving entity. The “viable” criterion can also comprise either a static or a dynamic parameter. When a static parameter, for example, a physical-exchange area may be required to meet a uniform set of minimal requirements regarding, for example, access conditions, size and shape dimensions, grade/incline, local lighting, shelter, local crime statistics, and so forth. When a dynamic parameter, requirements for a particular physical-exchange area to be “viable” may vary with such things as the day of the week or the time of day, the size and capabilities of the vehicular modality of the delivering entity itself, whether the vehicular modality of the delivering entity is operating wholly autonomously or under the guidance of a person, and so forth.

The criteria considered in the foregoing regards may be wholly as specified by the enterprise that seeks to effect delivery of the item to the receiving party or may be specified or at least influenced by input from the delivering entity 108 and/or the receiving entity 107 themselves. For example, the receiving entity 107 may specify preferences in these regards at the time of ordering the item and/or may maintain a profile in these regards that the control circuit 101 can access and factor in as appropriate.

Accordingly, the control circuit 101 filters the aforementioned information with respect to the aforementioned criteria to thereby identify a viable physical-exchange area that is sufficiently near the present location. Generally speaking, the identified area may be the area that is both viable and closest to the present location of the receiving entity. These teachings will accommodate other approaches, however. For example, a particular area may be used for this purpose that, while not an area that is closest to the present location of the receiving entity is otherwise more favorable in some regard (by, for example, offering shelter from inclement weather, better lighting or other attributes of security, better ingress and egress, and so forth).

After identifying the viable physical-exchange area that is sufficiently near the present location of the receiving entity 107, at block 204 the control circuit 101 transmits coordinating information that identifies the viable physical-exchange area to both the receiving entity 107 and to the relevant delivering entity 108 via the network interface to thereby coordinate a delivery of the physical item from the delivering entity 108 to the receiving entity 107. This transmission can presume use of a same transmission modality for both the receiving entity 107 and the delivering entity 108 or can presume use of different transmission modalities as desired. Transmission modalities can include but are not limited to email, text messages, in-app alerts, and voice messages (using live and/or pre-recorded or synthesized voice messages as desired).

The coordinating information, generally speaking, will at least include information that identifies the identified viable physical-exchange area. The location of the selected area may be identified using latitude and longitude information, inertial guidance information, street address information, and other information that may be helpful in these regards (such as a number that has been assigned to a parking space). The coordinating information may also include other helpful information, such as identifying information for a visual landmark that corresponds to the viable physical-exchange area such as a building name, a park name, and so forth.

The coordinating information can include other information as desired. As one example in these regards, the coordinating information can include a specified meeting time for the receiving entity 107 and the delivering entity 108 to meet at the indicated area. As another example in these regards, the coordinating information can include direct or indirect contact information for one or both of the receiving entity 107 and the delivering entity 108 to thereby facilitate and permit these two entities to communicate with one another to resolve any last moment logistical challenges or the like. As yet another example in these regards, the coordinating information can include images or other visual identification information regarding either or both of the receiving and delivering entities to facilitate ease of recognition and for increased security.

If desired, these teachings will accommodate other communications with one or both of these entities. As one example in these regards, the entity receiving one of the aforementioned communications may be expected to transmit a corresponding acknowledgment message (either automatically or non-automatically). As another example, one or both of the aforementioned entities may have current information that the identified viable physical-exchange area is, in fact, not presently viable. For example, a parking area may be closed for resurfacing or may be likely filled to capacity due to a local well-attended public event. In that case, the respective entity may transmit a response message to indicate the non-viability of the identified area.

Blocks 205-207 of FIG. 2 illustrate one example in these regards. In this example, at block 205, the control circuit 101 receives, via the network interface 103, a communication from the receiving entity 107 characterizing the viable physical-exchange area as being non-viable. At block 206 the control circuit 101 identifies an alternative viable physical-exchange area that is again sufficiently near the present location. At block 207 the control circuit 101 then transmits supplemental coordinating information that identifies this alternative viable physical-exchange area to both the receiving entity 107 and the delivering entity 108.

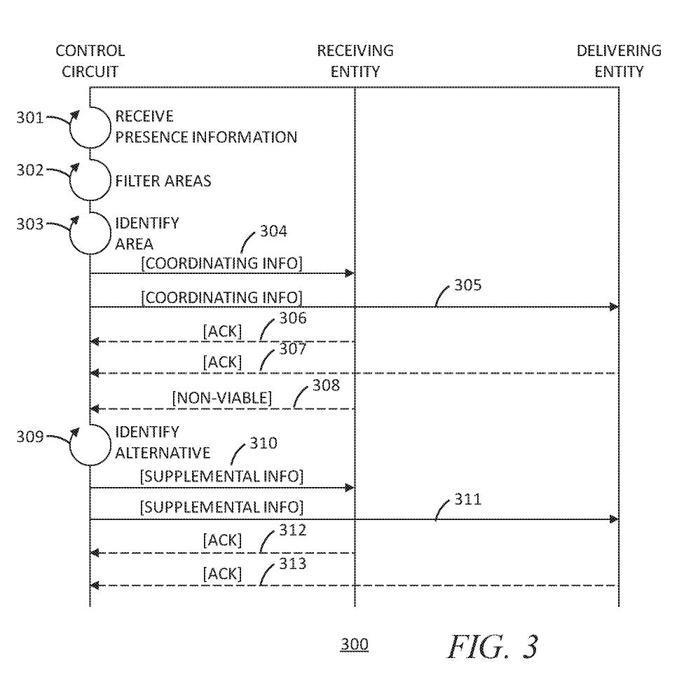

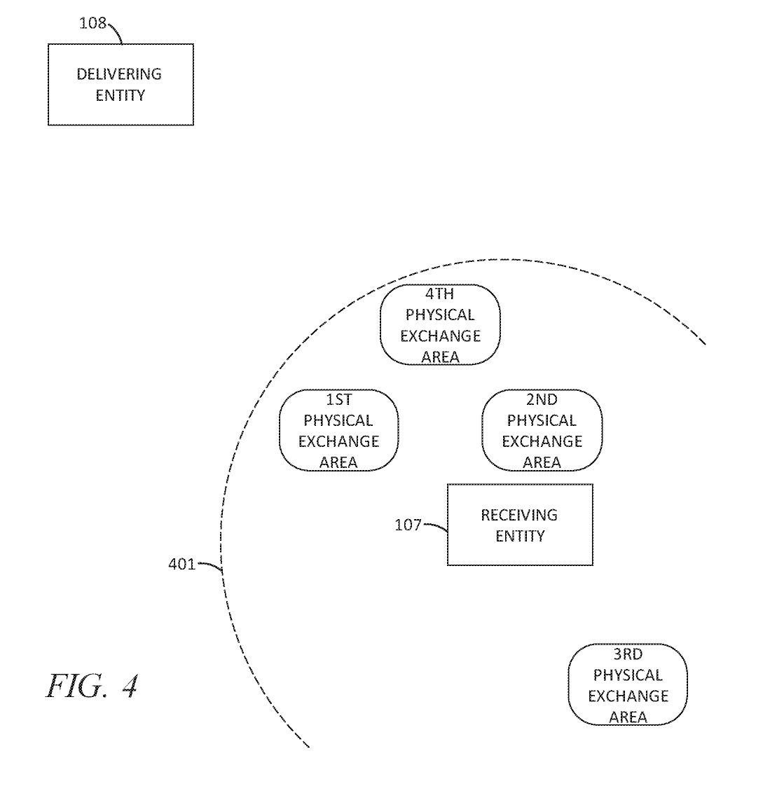

FIGS. 3 and 4 provide a further illustrative example in these regards. At 301 the control circuit 101 receives the aforementioned presence information and uses this presence information to ascertain a present location of the receiving entity 107. At 302 the control circuit 101 uses that present location of the receiving entity 107 to filter through a plurality of candidate physical-exchange areas and identify, at 303, one of these physical-exchange areas as being both sufficiently near the present location (in this case, by being within a predetermined distance 401 of the present location of the receiving entity 107) and being a viable physical-exchange area.

In this illustrative example, there are four physical-exchange areas that are sufficiently near the present location of the receiving entity 107 by virtue of being within the required predetermined distance. The physical-exchange area that is closest to the receiving entity 107 (denoted in FIG. 4 as being the second physical-exchange area), however, is a publicly-accessible parking lot that is known to the control circuit 101 to be inaccessible to the delivering entity 108 and is therefore classified as being non-viable. Accordingly, all other things being equal, the control circuit 101 identifies the so-called first physical-exchange area as the physical-exchange area to be used to deliver the ordered item to the receiving entity 107.

At 304 the control circuit 101 transmits corresponding coordinating information to the receiving entity 107 and at 305 does the same for the delivering entity 108. As illustrated in FIG. 3, these teachings will accommodate both the receiving entity (at 306) and the delivering entity (at 308) transmitting an acknowledgment message back to the control circuit 101 to acknowledge receiving the aforementioned messages.

In this illustrative example, however, the receiving entity 107 is aware, or at least believes, that the first physical-exchange area is not viable for these purposes. For example, the receiving entity 107 may be aware of road construction activity that will make it difficult or even impossible for one or both of the receiving entity 107 and delivering entity 108 to arrive at the first physical exchange area. Accordingly, in this example, at 308 the receiving entity 107 transmits a user-initiated message to the control circuit 101 to identify the suggested physical-exchange area as being nonviable.

In response, and as described above, at 309 the control circuit 101 repeats as appropriate the aforementioned process to identify an alternative physical-exchange area. In this example the control circuit 101 identifies the third physical exchange area as being a suitable replacement and accordingly transmits corresponding supplemental information (at 310) to the receiving entity 107 and (at 311) to the delivering entity 108. And again, if desired, the receiving entity and the delivering entity can respond with corresponding acknowledgment messages (as shown at 312 and 313).

So configured, a customer making a purchase that entails delivery of the purchased item can potentially take delivery of the purchased item without being at their ordinary or otherwise pre-established delivery address. This flexibility, in turn, makes it potentially possible to place the purchased item into the possession of the purchasing party even more quickly than might otherwise be possible. Accordingly, these teachings hold great potential for greatly increasing customer satisfaction and loyalty.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus to coordinate physical exchanges, comprising:
a network interface configured to receive presence information corresponding to a receiving entity and to transmit coordinating information;
a memory having stored information regarding physical-exchange areas;
a control circuit operably coupled to the network interface and to the memory and configured to:
determine a present location for the receiving entity using, at least in part, the presence information;
use the present location to filter the information regarding physical-exchange areas to identify a viable physical-exchange area that is sufficiently near the present location;
transmit coordinating information that identifies the viable physical-exchange area to both the receiving entity and to a delivering entity via the network interface to thereby coordinate a delivery of a physical item from the delivering entity to the receiving entity.

2. The apparatus of claim 1 wherein the presence information comprises at least one of:
latitude and longitude information;
inertial guidance information;
destination information identified in a navigation component.

3. The apparatus of claim 1 wherein the physical item comprises an item previously ordered and purchased by the receiving entity from a first enterprise.

4. The apparatus of claim 3 wherein the delivering entity comprises a second enterprise that is different from the first enterprise.

5. The apparatus of claim 1 wherein the viable physical-exchange area comprises a vehicular parking area.

6. The apparatus of claim 5 wherein the vehicular parking area comprises a public vehicular parking area.

7. The apparatus of claim 1 wherein the coordinating information further includes identifying information for a visual landmark that corresponds to the viable physical-exchange area.

8. The apparatus of claim 1 wherein the control circuit is further configured to:
receive, via the network interface, a communication from the receiving entity that characterizes the viable physical-exchange area as being non-viable.

9. The apparatus of claim 8 wherein the control circuit is further configured to:
in response to receiving the communication from the receiving entity that characterizes the viable physical-exchange area as being non-viable, identifying an alternative viable physical-exchange area that is again sufficiently near the present location and transmitting supplemental coordinating information that identifies the alternative viable physical-exchange area to both the receiving entity and to a delivering entity via the network interface to thereby again coordinate the delivery of the physical item from the delivering entity to the receiving entity.

10. A method to coordinate physical exchanges, comprising:
by a control circuit operably coupled to a network interface:
determining a present location for a receiving entity using, at least in part, presence information that corresponds to the receiving entity via the network interface;
using the present location to filter information regarding physical-exchange areas to identify a viable physical-exchange area that is sufficiently near the present location;
transmitting coordinating information that identifies the viable physical-exchange area to both the receiving entity and to a delivering entity via the network interface to thereby coordinate a delivery of a physical item from the delivering entity to the receiving entity.

11. The method of claim 10 wherein the presence information comprises at least one of:
latitude and longitude information;
inertial guidance information;
destination information identified in a navigation component.

12. The method of claim 10 wherein the physical item comprises an item previously ordered and purchased by the receiving entity from a first enterprise.

13. The method of claim 12 wherein the delivering entity comprises a second enterprise that is different from the first enterprise.

14. The method of claim 10 wherein the viable physical-exchange area comprises a vehicular parking area.

15. The method of claim 14 wherein the vehicular parking area comprises a public vehicular parking area.

16. The method of claim 10 wherein the coordinating information further includes identifying information for a visual landmark that corresponds to the viable physical-exchange area.

17. The method of claim 10 further comprising:
receiving, via the network interface, a communication from the receiving entity that characterizes the viable physical-exchange area as being non-viable.

18. The method of claim 17 further comprising:
in response to receiving the communication from the receiving entity that characterizes the viable physical-exchange area as being non-viable, identifying an alternative viable physical-exchange area that is again sufficiently near the present location and transmitting supplemental coordinating information that identifies the alternative viable physical-exchange area to both the receiving entity and to a delivering entity via the network interface to thereby again coordinate the delivery of the physical item from the delivering entity to the receiving entity.
